(19) United States
(12) Patent Application Publication
(10) Pub. No.: US 2019/0174795 A1
(43) Pub. Date: Jun. 13, 2019

(54) INOSINE MONOPHOSPHATE AS SOURCE OF ENERGY IN POULTRY DIET

(71) Applicants: Ramalho Rodrigueiro, Chapecó (BR); Alice Eiko Murakami, Maringá (BR)

(72) Inventors: Ramalho Rodrigueiro, Chapecó (BR); Alice Eiko Murakami, Maringá (BR)

(21) Appl. No.: 15/552,197

(22) PCT Filed: May 15, 2017
(86) PCT No.: PCT/BR2017/050114

§ 371 Date: Aug. 18, 2017

(30) Foreign Application Priority Data
Nov. 30, 2016 (BR) BR 1020160281180

(51) Int. Cl. A23K 20/153; A23K 50/75

(52) U.S. Cl. CPC A23K 20/153; A23K 50/75

(57) ABSTRACT

The present invention describes the use of inosine monophosphate as an energy source in feeds for slaughtering poultries by manipulating the energy of the diet to provide a reestablishment in weight gain and feed:gain ratio of slaughter birds fed with lower caloric diet. Inosine monophosphate is applied in feed to meet the nutritional requirement energy in poultries by partially replacing soybean oil or fats commonly used as energy sources in poultries diets.

The present invention relates to the use of inosine monophosphate as a source of energy in feeds for slaughtering poultry, such as broiler chickens, ducks, quails and turkeys, belonging to the technological sector of additives used in poultries diets.

### HISTORY OF THE INVENTION

Additives used in feed for poultries are known to the man, which aim to reduce production costs and improve the performance.

In broiler chickens production, genetic improvement, globalized competitiveness and the cost of ingredients are the basic points that encourage researchers to understand and develop models to reduce the cost of production. Feeding is the crucial point to be investigated, once achieve around 70% of total poultry production costs, with energy, protein and phosphorus being the elements that most affect the cost of the diet, respectively

The reduction of crude protein of the diet associated with the supplementation of synthetic amino acids is an important nutritional strategy applied by the nutritionist to reduce the cost of feed without affecting the broiler chickens performance. Also, the effect of enzyme phytase on the bioavailability of the phytate, an important antinutritional factor, is an example to reduce the application of phosphate dicalcium in the diet. Finally, the valorization of digestibility of starch and non-starch polysaccharides done by carbohydrase enzymes is another important topic diagnosed as a nutritional tool to improve the energy efficiency of poultry diet with consequent reduction of costs of broilers production.

Carbohydrase enzymes in broiler diets have been widely used in animal nutrition in order to valorize dietary energy. However, the energy efficiency of a diet does not seem to be entirely dependent on the increased availability, for example, of glucose in the gut or blood glucose rate, but also, it seems to be dependent on how efficient the body is in synthesizing ATP (adenosine triphosphate) from glucose and fatty acids.

The molecules rich in energy in the animal diet such as glucose and fatty acid, when absorbed by the gut, are metabolized by a series of oxidation reactions, producing CO₂ and H₂O. The intermediates of these reactions donate electrons to nicotinamide adenine dinucleotides coenzymes (NAD+) and flavin adenine dinucleotides (FAD) to make coenzymes reduced, rich in energy, NADH and FADH₂. Then these reduced coenzymes donate a pair of electrons to a specialized set of electron carriers. At the end, the electrons pass through the electron transport chain and lose their energy. Some of this energy can be captured and stored as ATP from ADP+inorganic phosphate (Pi). This process is called oxidative phosphorylation. The rest of uncaught free energy as ATP is released as heat.

As it can be seen, the krebs cycle acts as the main pathway of lipids and carbohydrates oxidation, producing a great quantity of ATP and GTP, nucleosides purines linked by three molecules of phosphorus. The energy value of GTP is the same of the ATP and the both nucleotides are interconvertible by the reaction of the enzyme nucleosides diphosphate kinase.

The amount of ATP within the cell are strictly regulated and is available for a short period of time characterized by high energy needs, and the creatine is an important element for maintaining the energy balance in the muscle cells. Therefore, this energetic reserve is ephemeral, being used when the muscle needs the maximum effort. Also the regeneration of ATP has to come by anaerobic via, using glycogenic and glucose until lactic acid, and, aerobic via, from glucose, fatty acids and proteins, producing CO₂ and H₂O.

How can it be observed, the energetic metabolism is complex, occurring the natural lose of energy due inefficiencies intermediary metabolism necessary for the digestion, transport, excretion and transformation of usable nutrients. These losses are referred as heat increment. The organism hold an energetic efficiency around 40%, being 58.8% of the metabolism is lost as heat.

The concept that ATP, a nucleotide adenine linked with three molecules of phosphorus, is the universal energy source for the cells, determines that any factor to increase its synthesis or its availability within the cell, can directly to affect the balance of the energy in the diet.

The nucleotides purines like inosine monophosphate (IMP), guanine (GMP) and adenine (AMP) as an intermediate of energy in animals and its effect subject is well defined by the biochemistry, however no scientific studies have been made if its supplementation in broiler chickens diet could be influenced directly on the metabolism of the energy.

Among the purines required to understand its effect on the oxidative phosphorylation process, the IMP seems to be the most indicated because it is the precursor of AMP and GMP. In metabolism, AMP and GMP are acceptors of phosphate groups to form ATP and GTP which occupy intermediate positions in the bioenergetic scale of the phosphate compounds.

Energy is not chemically identifiable as a nutrient but is a property obtained when nutrients, such amino acids, carbohydrates, and lipids, are oxidized during metabolism. The energy of the diet consumed by the animal can be used in three different ways: it can supply the energy for activity, it can be converted to heat, or it can be stored as body tissue. Dietary energy exceeding the necessity of the body for normal growth and metabolism of the bird is usually stored as fat. Excess available energy cannot be excreted by the animal body. Optimum nutrient utilization by the chicken is achieved when the diet contains the proportion of energy to other nutrients needed to produce the desired growth, egg production and deposition of protein in the body. The major portion of all feed consumed by an animal is used for energy since both anabolic and catabolic reactions create a demand for energy.

Metabolizable energy (ME) is the current recommendation to the birds. At the metabolism is estimated some losses due to inefficiencies in intermediary metabolism which are necessary to digest, transport, excrete waste from, and transform nutrients into usable form. These losses are referred to as the heat increment. The size of increment varies with the composition of the diet. In chickens, the heat increment is generally considered to be about 30% of the ME for protein, 15% for starch, and 10% for lipid. Independent of energy losses done by body, in fact the carbon and hydrogen present into the raw materials can be oxidized to carbon dioxide and water producing adenosine triphosphate (ATP) and guanine triphosphate (GTP), nucleotides purines that are distributed in every cells of the body. In birds, the metabolic reactions that oxidize nutrients capture about 40% of the energy as adenosine triphosphate (ATP), which is available for anabolic, catabolic, osmotic, or mechanical work. When the ATP loses a phosphate group to form ADP around 8 kcal/moles are released.

The nutritionist has the feedstuff as unique source of energy for the animals due to the knowledge in terms of the digestible and value of energy of the carbohydrates, fats and proteins.

The production of moles of ATP per grams of glucose, starch, protein, lipids, volatile fatty acids and fermentable carbohydrates is 0.211; 0.235; 0.194; 0.508; 0.212 and 0.165, respectively.

On the other hand, to establish the nucleotides purines as a possible source of energy in animal nutrition is not recognized by the researchers, feed manufactures and poultry industries.

For more than two decades, the study of nucleotides and nucleic acids has been a topic of interest among researchers because of the many functions attributed of them. Scientific evidence suggests that nucleotides are important because their participation in physiological reactions is essential to the maintenance and propagation of the life. The nucleotides are involved in almost cell processes and play a major role in structural, metabolic, energetic and regulatory functions. They make up the monomeric units of RNA and DNA; RNA synthesis is required for protein synthesis and DNA synthesis is required for growth and cell division. Adenosine triphosphate, an adenine nucleotide, is the major source of the chemical energy used by the metabolism, driving almost all cellular processes. Nucleotides are physiological mediators in a number of metabolic processes, cyclic adenosine monophosphate (cAMP) and cyclic guanine monophosphate (cGMP) regulating a large number of cellular events.

The nucleotides are endogenously synthesized; therefore, they are not essential nutrients. On the other hand, in feed application, the nucleotides can improve the immune system, growth and increase the intestinal villi, metabolism of lipids and liver functions. Dietary supplementation of the nucleotides save time and energy to the body to form nucleotides by de novo biosynthesis or by salvage of preformed bases. The conditionally essential effect can be used to define the action of the nucleotides in human or animal nutrition. Under these conditions, the exogenous consumption of nucleotides in the diet saves the body from taking the costs of de novo synthesis and the salvage pathways.

The absorption process of the nucleotides and its nitrogenous bases by the enterocytes occurs throughout an active sodium-dependent transport or facilitated diffusion. In healthy adult animals receiving purines, 90% of ingested nucleotides are absorbed through the intestine.

Dietary purines are not significantly incorporated into hepatic nucleic acids, but pyrimidines are. Both are taken up by intestinal cells and the excess of purines are converted to uric acid.

The liver is the major site for synthesis of purines in animal body. The citosol of the cell contain all the enzymes for synthesis and degradation of purines. The synthesis of IMP needs 4 ATP and 10 steps, beginning with 5-phosphoribosyl 1-pyrophosphate (PRPP), 2 glutamines, 1 glycine, 2 formyl-tetrahydrofolate molecules and CO2. Finally, the conversion of IMP to AMP or GMP is a two-step route, requiring 1 molecule of energy, that is, for AMP synthesis 1 GTP is required and for GMP synthesis 1 ATP is required.

The IMP is classified as a nucleotide purine called “mother of nucleotides”, because inosine 5-monophosphate serves as a branch point for the conversion of both AMP and GMP synthesis. At the metabolism, the AMP and GMP are acceptors of the phosphate group to synthesize ATP and GTP which occupy an intermediates position of the bioenergetics scale of the phosphates compounds. Depend on the cells necessities, from IMP the organism will be synthesizing AMP or GMP.

Based on the different physiological roles of the nucleotides in the organism of the animals, the ATP is the most abundant source of chemical energy used in the metabolism, controlling most cell processes, serving as stock of energy. The active transport of molecules and ions, the synthesis of macromolecules and the mechanical work are entirely dependent on the energy supply in the form of ATP. Adenine is an important regulator of blood flow and muscle activity. Also, cAMP and cGMP are mediators of numerous metabolic processes, regulating a large number of metabolic reactions.

The nucleotides diphosphate and triphosphate are synthesized from nucleosides monophosphate correspondent by the nucleosides kinase enzyme specific. Then the purines resultant of the normal endogenous metabolism of nucleic acids or that come from diet can be converted in nucleotides triphosphate and can be utilized by the body. In this case, two enzymes are involved; the adenine phosphoribosyltransferase (APRT) and the hypoxanthine-guanine phophoribosyltransferase (HGPRT). Both enzymes have caught the PRPP as source of ribose 5-phosphate and the final product of the purines is the uric acid. Uric acid is an insoluble complex formed and is excreted as sodium crystals in the urine. Mammals, except primates, oxidize the uric acid to allantoin, which in some non mammalian animals may be degraded in urea or even ammonia.

The production rate of AMP and GMP provides a negative feedback, inhibiting adenylsuccinate synthetase enzymes and IMP dehydrogenase. The amidinotransferase reaction that is catalyzed by glutamine: phosphoribolsyl pyrophosphate amidinotransferase (PRPP amidinotranferase) is also inhibited by ATP, AMP, GTP and GMP. If both, AMP and GMP are present in adequate amounts, the de novo route of the purine synthesis is deactivated in the aminotransferase step.

Although the reports show the potential of purines as a source of metabolic energy for animals, IMP is currently classified as flavor enhancer, having an important role in the food industry, contributing to the Umami taste, a taste stimulus caused by amino acids and nucleotides that interact with the taste cells of the tongue. The tympanic cord nerve that innervates the anterior part of the tongue, evidences the sharp perception of the amino acid taste (umami, sweet or bitter). In the Umami taste, there are receptors on the tongue that are sensitized with the presence of glutamate and the inosinate nucleotides. IMP enhances the taste of food when associated with glutamate. Also, within the same description of nucleoside inosine effect, AMP has been studied as an important regulatory role in inflammation and immunity.

However, the information present in the biochemistry of energy metabolism leaves evidence that IMP supplementation in animal diet, the organism can respond not only as a flavor enhancer but also as an element that can synthesize ATP and GTP in the body, being a possible source of energy for birds.

In a disadvantageous way, the use of IMP as an energy source in feeds for poultry feed is not known, which can be an alternative to reduce the production costs of these feed and, consequently, reduce the costs of poultry production.

In order to find a source of energy for commercial poultry production, the present invention proposes the use of IMP as an energy source in feed for broilers by manipulating the feed energy in order to decrease the cost of manufacturing feed and, consequently, also lowering the costs of poultry production.

Advantageously, the present invention provides the use of IMP as energy source in feed for birds, using broiler chicken as animal model, so that IMP can regenerate the performance of broilers as a new source of energy to be used by feed manufacturers and poultry farmers.

### DESCRIPTION OF THE INVENTION

The present invention describes the use of IMP as energy source in poultries, using broiler chickens as animal model, by manipulating the energy of the diet to provide a reestablishment in body weight gain and feed:gain ratio of birds fed with lower calorie diet.

The IMP is applied at the diet in order to meet the nutritional requirement of poultry energy by partially replacing soybean oil or animal fat commonly used as energy sources in poultry feed. Preferably, the IMP is applied to represent 100 kcal/kg of feed, so that the caloric components (soybean oil or animal fat) of the feed are reduced by about 1.0% to 2.0% in the complete feed. Such reduction of energy is supplied by the action of IMP as a source of energy in the feed, providing better energy utilization by birds.

Figures are presented of a private invention, the values and proportions of which are not necessarily real, since the figures are merely intended to present their various aspects, whose scope of protection is determined only by the scope of the claim attached.

### DESCRIPTION OF THE PICTURES

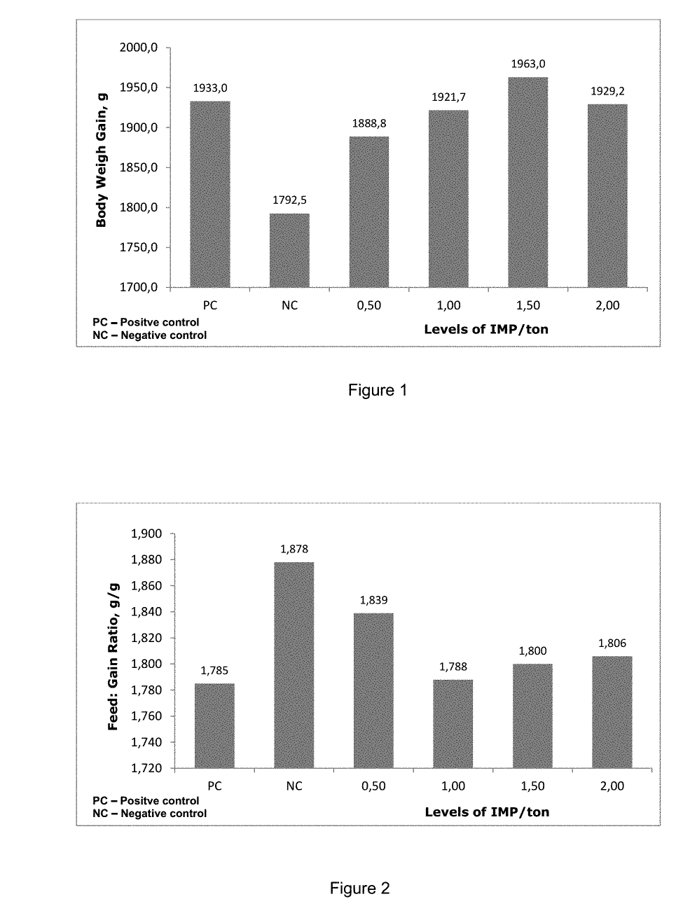

The FIG. 1 illustrates a graph, demonstrating the effect of treatments on body weight gain of broilers at 42 days of age, according to the application of the invention;

The FIG. 2 illustrates the graph, demonstrating the effect of treatments on feed:gain ratio of broilers at 42 days of age, according to the application of the invention;

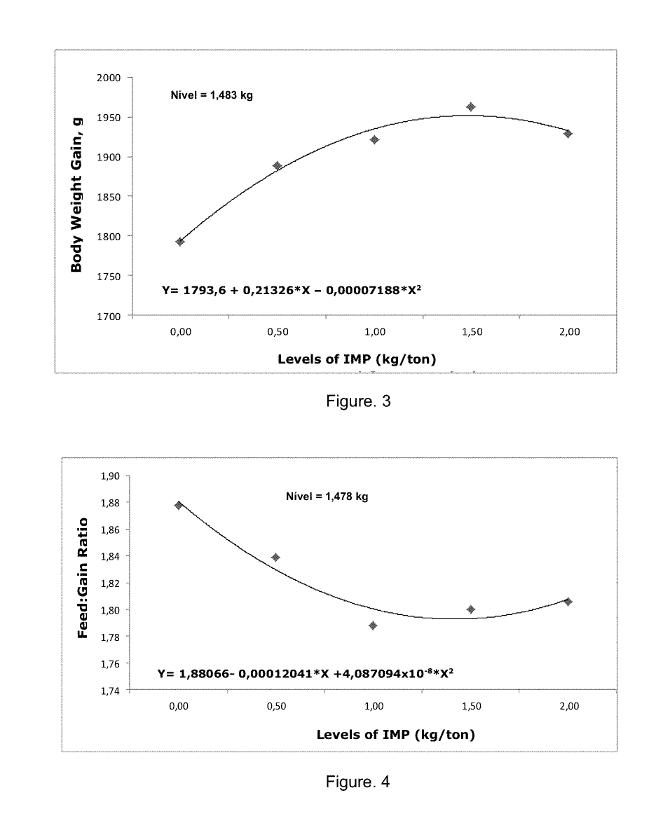

The FIG. 3 illustrates a graph showing the levels of IMP on the body weight gain of broiler chickens fed a diet containing 3025 kcal ME/kg at 42 days of age, according to the application of the invention;

The FIG. 4 illustrates a graph showing the levels of IMP on the feed:gain ration of broiler chickens fed a diet containing 3025 kcal ME/kg at 42 days of age, according to the application of the invention;

### DESCRIPTION OF THE INVENTION

The present invention addresses the use of IMP as an energy source in feeds for poultries, using broiler chickens as animal model, by manipulating energy of the diet to provide a reestablishment of body weight gain and feed:gain ratio of birds fed with lower calorie diet.

The IMP is applied at the diet to meet the nutritional requirements of poultry energy. It is known that any reduction of energy of the diet will be reduced the body weight gain and the feed:gain ratio will be increased. However, the application of IMP in feed provides the maintenance of body weight gain and feed:gain ratio of birds.

Thus, IMP is used to partially replace soybean oil or animal fats commonly used as energy sources in poultry diet. Preferably, the IMP is applied to represent 100 kcal ME/kg of feed so that the caloric components (soybean oil or animal fat) of the feed are reduced to about 1.0% to 2.0% in the compete feed. Such reduction of energy is supplied by the action of the IMP as a source of energy in the feed, providing a better use of energy by birds.

In an example of application of the present invention, a standardized diet for broilers with 3125 kcal ME/kg, having 3.3% of its final diet composition defined by soybean oil, is manipulated so that its amount of metabolizable energy (ME) is reduced to 3025 Kcal or minus 100 kcal/kg. Thus, the IMP is composed of 100 kcal/kg, representing 1.1% of the final diet composition, while soybean oil is composed of 2.2% of the complete feed composition. Still, the other components of the feed are not changes, as shown in the table below.

TABLE 1
Composition of basal diet, %.

| Ingredients | Positive Control, % | Negative Control, % |
|---|---|---|
| Corn | 62.70 | 62.70 |
| Soybean meal 45% CP | 30.90 | 30.90 |
| Soybean Oil | 3.30 | 2.20 |
| Phosphate dicalcium | 1.10 | 1.10 |
| Inert | 0.00 | 1.10 |
| Limestone | 0.74 | 0.74 |
| Salt | 0.45 | 0.45 |
| Premix | 0.40 | 0.40 |
| DL-Methionine | 0.236 | 0.236 |
| L-Lysine | 0.170 | 0.170 |
| L-Threonine | 0.026 | 0.026 |
| Nutricionals levels, % | | |
| ME, kcal/kg | 3.125 | 3.025 |
| Protein, % | 19.60 | 19.60 |
| Calcium, % | 0.685 | 0.685 |
| Phosphorus, % | 0.320 | 0.320 |
| Na, % | 0.198 | 0.198 |
| K, % | 0.747 | 0.747 |
| Cl, % | 0.322 | 0.322 |
| Arginine dig, % | 1.192 | 1.922 |
| Lysine dig, % | 1.044 | 1.044 |
| Methionine dig, % | 0.495 | 0.495 |
| Met + Cys dig, % | 0.762 | 0.762 |
| Threonine dig, % | 0.679 | 0.679 |
| Tryptophan dig, % | 0.210 | 0.210 |
| Valine dig, % | 0.815 | 0.815 |
| BE mEq/kg | 186 | 186 |

More precisely, the application of the manipulated diet (3025 kcal ME/kg) using approximately 1.478 to 1.483 kg of IMP per ton of feed, identified at the Table 1 as the negative control, gives the value of approximately 100 kcal of metabolizable energy (ME) for birds fed by this diet.

As an example of this application with feed manipulated by the IMP, this diet was used in broilers reared into of specific facility. The north and south sides of this broiler house was built 1.0 meter high walls, followed by bird-proof screens until the roof. For better temperature control inside of experimental facility, curtains were placed in each side of the barn. Also, the fans were connected according to the environmental need and behavior of the birds. The floor of the experimental facility was made of concrete and the metabolism cages were suspended around 1.0 meter high and arranged in four rows. Each row contained 12 cages spanning a total of 48 cages.

The light program used was 24 hours of natural-artificial light throughout the experimental period (18 to 42 days of age) and water and feed were provided ad libitum. The removal of manure from the concrete floor was performed daily to avoid high ammonia concentration inside the broilers house. Also, daily cleaning of drinkers and cages was carried out daily. Fresh and clean water was supplied daily.

A total of 144 Cobb 500 males of 18 days old were distributed in metabolism cages using a completely randomized design with 6 treatments (2 control diets+4 levels of IMP) and 8 replicates of 3 birds each.

The positive control diet based on corn and soybean meal was formulated to meet the nutritional recommendations for the growth phase (18 to 42 days of age). On the other hand, the negative control diet was formulated with a reduction of 100 kcal ME/kg when compared to the positive control diet (Table 1). The 4 levels of IMP replaced the inert of the negative control diet considering the inclusion of 0.50 kg; 1.0 kg; 1.5 kg and 2.0 kg of IMP per ton of feed.

The birds and the diets were weighed at 42 days of age for performance evaluation (feed intake, body weight gain and feed:gain ratio). The bird mortality was recorded daily as well as its possible causes. Dead birds were weighed to adjust feed intake and feed:gain ratio.

The statistical analysis was used to determine the effect of IMP on the performance of broilers. The data was submitted to the GLM procedure of the SAS software, and the means comparisons were performed by SNK (Student-Newman-Keuls) test at 5% probability, following the mathematical model: Yij=μ+si+eij, where:

Yij=Observation referring to the animal j that received treatment i;
p=general mean;
si=treatment effect i
eij=random error associated with each observation.

Contrast analyzes were performed to compare the positive and negative control diets and the other treatments. The data obtained from each parameter were deployed in orthogonal polynomials for analysis of variance and regression according to their distributions, without considering the positive control treatment using SAS software.

The performance result obtained in the period from 18 to 42 days of age as a function of different levels of IMP is presented in Table 2.

TABLE 2
Performance of broilers fed from 18 to 42 days of age
depending on the different levels of IMP.

| Trataments | BWG (g) | FI (g) | FGR (g/g) |
|---|---|---|---|
| Positive control (PC) | 1933.0 a | 3439.2 | 1.785 b |
| Negative control (NC) | 1792.5 b | 3419.6 | 1.878 a |
| NC + IMP (500 g/ton) | 1888.8 a | 3484.4 | 1.839 ab |
| NC + IMP (1000 g/ton) | 1921.7 a | 3479.4 | 1.788 b |
| NC + IMP (1500 g/ton) | 1963.0 a | 3542.4 | 1.800 b |
| NC + IMP (2000 g/ton) | 1929.2 a | 3473.9 | 1.806 b |
| SEM | 14.48 | 16.24 | 0.01 |
| P-Valor | 0.01 | 0.35 | 0.002 |
| Contrast | | | |
| PC vs NC | 0.003 | — | 0.001 |
| PC vs IMP | 0.83 | — | 0.23 |
| NC vs. IMP | 0.001 | — | 0.001 |
| Regression of IMP | Q = 0.02 | 0.17 | Q = 0.03 |

ab Average followed by different letters at the same column is different by SNK test (P < 0.05).
IMP = inosine monophosphate;
Q = Quadratic effect.
BWG = body weight gain.
FI = feed intake.
FGR = feed:gain ratio

By contrast, birds received negative control treatment (lower caloric level or 3,025 kcal ME/kg), significantly reduced the body weight gain and worsened feed:gain ratio, without, however, influencing the consumption (P≥0.05) when compared to the other treatments.

Except for the lower energy present in the negative control diet, the other nutrients met the requirement of the birds in the 18 to 42 days old. Thus, it can be concluded that the reduction of the body weight gain and the worsening in the feed:gain ratio were totally responsible for the lower level of metabolizable energy.

In Nutritionofthechicken (of 1982, p. 562), Scott et al. report that the level of energy in the diet seems to be an important factor that determines the feed intake since the birds do not have the taste as the factor that influences the feed intake. Thus, the authors noted that birds tend to increase feed intake when the energy content is reduced, but not enough to obtain adequate amount of energy per day for optimal growth. In turn, reducing energy to a critical level, growth will be reduced and there will be low fat content in the carcass. However, the application example of this invention reported the opposite.

As expected, the birds fed the positive control diet (3125 kcal ME/kg), due to the higher concentration of soybean oil, presented higher body weight gain and better feed:gain ratio when compared with birds fed with the negative control diet (3025 kcal ME/kg). This improvement can be attributed to the increase in caloric density that improves energy efficiency by increasing the net energy of the feed.

Contrast showed that the inclusion of IMP significantly improved the body weight gain and feed:gain ratio when compared to those boilers fed by negative control diet (3025 kcal ME/kg). Regardless of the level of IMP used, there was no effect on feed intake (P≥0.05) when compared to the positive and negative control treatments. Conclusively, it is possible to say that the IMP has a potential source of energy in poultries diet, since when it was included in the diet with a lower metabolizable energy content (3025 kcal ME/kg), the chickens achieved the same body weight gain and feed:gain ratio rate as those fed with 3125 kcal ME/kg (positive control), establishing in this experiment an energy potential around 100 kcal ME/kg for broiler chickens. In FIGS. 1 and 2, can observed the body weight gain and the feed:gain ratio, respectively, of the broilers submitted by the treatments.

Based on the fact that the contrast did not show significant differences in the performance of broilers fed with IMP when compared to the positive control, in order to obtain the recommendation of IMP in broiler chickens diets in the period from 18 to 42 days of age, the data from body weight gain and feed:gain ratio were plotted in orthogonal polynomials for regression analysis without considering the positive control treatment. This can be seen in FIGS. 3 and 4, respectively.

Increased levels of IMP in the 3025 kcal ME/kg (negative control) showed quadratic effect (P≥0.05) for body weight gain and feed:gain ratio. The IMP recommendation determined by the polynomial regression equation was 1.483 kg and 1.478 kg of IMP/ton for body weight gain and feed:gain ratio, respectively.

As the inclusion of IMP occurred only in the corn and soybean meal diet containing 3025 kcal ME/kg (negative control), it is justified that the broilers consumed an isocaloric and isoprotein diet. Thus, the improvement of body weight gain and feed:gain ratio is due exclusively to the presence of IMP in the diet.

The man of the art will readily perceive, from the description and the figures, various ways of carrying out the invention without departing from the scope of the appended claims.

1- “USE OF INOSINE MONOPHOSPHATE AS SOURCE OF ENERGY IN POULTRY DIET”, characterized in that inosine monophosphate is applied in the composition of diet for birds to manipulate the energy of the feed, partially replacing the caloric components of the feed.

2- “USE OF INOSINE MONOPHOSPHATE AS SOURCE OF ENERGY IN POULTRY DIET”, according to claim 1, characterized in that inosine monophosphate partially replace the soybean oil in the feed.

3- “USE OF INOSINE MONOPHOSPHATE AS SOURCE OF ENERGY IN POULTRY DIET”, according to the claim 1, characterized in the inosine monophosphate partially replaces the animal fat in the feed.

4- “USE OD INOSINE MONOPHOSPHATE AS SOURCE OF ENERGY IN POULTRY DIET”, according to the claim above, characterized in the inosine monophosphate represent the value of 100 kcal ME/kg or 1.0 to 2.0% of final composition of the diet

5- “USE OF INOSINE MONOPHOSPHATE AS SOURCE OF ENERGY IN POULTRY DIET”, according to one of the preceding claims, characterized in that it represents the application of approximately 1.478 to 1.483 kg of inosine monophosphate per ton of feed.

6- “USE OF INOSINE MONOPHOSPHATE AS SOURCE OF ENERGY IN POULTRY DIET”, according to claim 1, characterized in that inosine monophosphate is applied in a feed according to the following composition: 62.70% corn; 30.90% soybean meal 45% PB; 2.20% soybean oil; 1.10% of dicalcium phosphate; 1.10% inosine monophosphate; 0.74% limestone; 0.45% of common salt; 0.40% Premix; 0.236% DL-Methionine; 0.170% L-Lysine; And 0.026% L-Threonine.
